(19) United States
(12) Patent Application Publication
(10) Pub. No.: US 2025/0377537 A1
(43) Pub. Date: Dec. 11, 2025

(54) EYE TRACKING CALIBRATION

(71) Applicant: Apple Inc., Cupertino, CA (US)

(72) Inventors: Paul X. Wang, Cupertino, CA (US); Fletcher R. Rothkopf, Los Altos, CA (US); Edith M. Arnold, Redwood City, CA (US)

(21) Appl. No.: 18/739,330

(22) Filed: Jun. 11, 2024

(51) Int. Cl. G02B 27/00; G02B 27/01; G06F 3/01

(52) U.S. Cl. CPC G02B 27/0093; G02B 27/0172; G02B 27/0176; G06F 3/013; G02B 2027/0138

(57) ABSTRACT

A head-mountable display can include a display, an eye tracking assembly including a camera configured to detect a gaze direction of a user donning the display, and a controller electrically coupled to the display and the eye tracking assembly, the controller configured to execute a gaze direction calibration including detecting, via the camera, the gaze direction when the user looks at a visual icon representing a user-selectable software function, wherein the user-selectable software function includes a separate function independent of the gaze direction calibration.

### FIELD

The described embodiments relate generally to electronic devices. More particularly, the present embodiments relate to head mountable electronic devices.

### BACKGROUND

Recent advances in portable computing have enabled head-mountable devices that provide augmented and virtual reality experiences to users. These devices include display screens or viewing frames to present images and video content for an immersive and comfortable experience. To provide clear images and effective use of the head mountable devices, the display screens are calibrated to the position and gaze of the user's eyes. However, existing calibration methods often require lengthy and specialized procedures that disrupt normal use of the head mountable devices.

Additionally, head-mountable devices can be used in a variety of different settings and during a variety of different activities, as well as in various different orientations. These can range from lying down or reclined, leaning forward, or an upright position. These changes in position of the user can cause changes in positions of the display screen or other features resulting in mis-calibrated headsets.

Accordingly, what is needed in the art are head-mountable devices and systems providing improved and easy to use calibration systems or methods.

### SUMMARY

In at least one example of the present disclosure, a head-mountable display can include a display, an eye tracking assembly including a camera configured to detect a gaze direction of a user donning the display, and a controller electrically coupled to the display and the eye tracking assembly, the controller configured to execute a gaze direction calibration including detecting, via the camera, the gaze direction when the user looks at a visual icon representing a user-selectable software function. In some examples, the user-selectable software function includes a separate function independent of the gaze direction calibration.

In another example of the head mountable display or electronic device, the head mountable display includes a housing coupled to the display and a securement band coupled to the housing and configured to secure the head-mountable display to a head of the user. The eye tracking assembly can further include a light emitting diode configured to reflect light off of an eye of the user to the camera. In another example of the head mountable display the separate function includes typing and the visual icon includes a keyboard. In another example of the head mountable display the separate function includes a user-interface unlock function. In another example of the head mountable display the visual icon includes a number pad. In another example of the head mountable display the controller is configured to cause the video streaming window to move relative to a peripheral edge of the display. In another example of the head mountable display at least one dimension of the visual icon representing a user-selectable software function is increased or decreased during gaze direction calibration.

In at least one example of the present disclosure, an electronic display device includes a display, a camera, and a controller electrically coupled to the display and the eye tracking assembly, the controller configured to cause the display to project a visual icon representing a user-selectable software function, the visual icon having a characteristic, and execute a gaze direction calibration including altering the characteristic when a user looks at the visual icon, and detecting, via the camera, the gaze direction when the user looks at the visual icon.

In another example of the electronic display device the user-selectable software function includes a separate function independent of the gaze direction calibration. In another example of the electronic display device the characteristic includes an amount of light emitted by the visual icon on the display. In another example of the electronic display device the characteristic includes a size of the visual icon. In another example of the electronic display device the characteristic includes a location of the visual icon on the display. In another example of the electronic display device the visual icon includes a video streaming window. In another example of the electronic display device the controller is configured to alter the location of the video streaming window by moving the video streaming window relative to a peripheral edge of the display.

In at least one example of the present disclosure a wearable display device includes a display defining a viewing area having a peripheral edge, controller electrically coupled to the display and configured to cause the display to project a video streaming window within the viewing area, and change a location of the video streaming window relative to the peripheral edge over time.

In another example, the wearable display device further includes a housing coupled to the display, and a position sensor electrically coupled to the controller and configured to detect a position of the housing, and the controller is configured to change the location based on the position. In another example of the wearable display device the controller is configured to cause the display to project a visual icon in a fixed position relative to the video streaming window, the wearable display device further includes a camera, and the controller is electrically coupled to the camera and configured to execute a gaze direction calibration including detecting, via the camera, the gaze direction when the user looks at the visual icon when the video streaming window location is changing. In another example of the wearable display device the visual icon represents a user-selectable software function independent from the gaze direction calibration. In another example of the wearable display device the camera is adjacent the display.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an interior view of an example of a head mountable device including a display;

FIG. 2 shows a side view of the example head mountable device of FIG. 1 worn by a user;

FIG. 3A shows an example visual depiction of a user-selectable software function depicted at a display for gaze direction calibration;

FIG. 3B shows a second configuration of the example visual depiction of a user-selectable software function depicted in FIG. 3A;

FIG. 3C shows a second configuration of the example visual depiction of a user-selectable software function depicted in FIG. 3A;

FIG. 4 shows an example of user-selectable software functions depicted on an example display for gaze direction calibration;

FIG. 5 shows an example of a display of the head mountable device including icons arranged for gaze direction calibration;

FIG. 6A shows an example of content including a video streaming window depicted on an example display for gaze direction calibration;

FIG. 6B shows the example content for gaze direction calibration of FIG. 6A arranged in a second example configuration;

FIG. 7A shows another example of the head mountable device including a fitment feature worn by a user in a first orientation;

FIG. 7B shows the example of the head mountable device including a fitment feature of FIG. 7A worn by a user in a second orientation; and

FIG. 7C shows an example display for gaze direction calibration of the head mountable device of FIG. 7A or 7B.

FIG. 8 shows a schematic diagram of an example computer system as used to perform one or more functions of the head mountable device.

### DETAILED DESCRIPTION

Detailed reference will now be made to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to head-mountable electronic devices or displays. In at least one example, a head-mountable device can include a housing and a securement feature for positioning the head mountable device on a head of a user. The head mountable device includes a display for viewing visual content. The display can be coupled to the housing and positioned in front of the eyes of a user. The head mountable device can include one or more eye tracking assemblies. The eye tracking assemblies can include sensors, such as cameras, or light emitting elements to determine a gaze direction of the eyes of the user. The head mountable device can include one or more sensors to track gestures or physical actions by the user, such as movements of the arms, hands, head, or the like. The tracked gestures can be used to determine commands or inputs to the head mountable device. In some examples, the head mountable device can be associated with one or more input devices, such as controllers, to provide commands to the head mountable device.

The head mountable device can display content, such as visual portions of executable software or applications. The applications can include user selectable software functions represented by the visual content, such as icons or user interfaces, depicted at the display. The icons or user interfaces can be selected by determining the gaze direction of the user's eyes in combination with an input from an input device or gesture of the user. The gaze direction of the user can be compared with known positions of the content at the user display to identify the selected visual content. Many visual portions of the executable software or applications can contain multiple user selectable software functions, such as multiple icons, drop down menus including multiple options, and the like. Accordingly, a precise or refined determination of the gaze direction is important to reliably and repeatedly associate the desired visual content with the gaze direction of the user.

To determine the gaze direction of a user, the head mountable device can be calibrated. The calibration can be done initially when the head mountable device is first used or during use. Also, gaze direction calibration can be performed periodically with use to ensure accurate and precise gaze detection functions over time. In some examples, the head mountable device can include specialized executable software functions to perform calibration. For example, a specialized software can depict visual content at the display at known positions designed to assist in determining the direction of the users gaze. However, activating or performing the steps required by a specialized software function can disrupt or take time away from a user's experience of the other or desired applications. Accordingly, there is a need for calibration systems and methods using existing applications or applications already selected by a user (e.g. native applications).

The existing or native applications can be represented by one or more user selectable functions or visual icons at the display of the head mountable device. The positions of the visual icons at the display can be known. To calibrate the head mountable device using the existing or native applications, the eye tracking assembly can determine or detect a gaze direction of the user to known positions of the visual icons when the user attempts to select the visual icons. Differences in the actual position and the determined positioned can be identified and corrected to calibrate the head mountable device and the gaze detection functions thereof. In some examples, the visual icons can be commonly used or predicted for a user to select or interact with the icon by, in part, directing their gaze to the icons. Various characteristics of the visual icons such as the dimensions of the visual icons, positions of the icons, movements of the icons, or the like can be altered to refine or improve the gaze calibration. In some examples, the background or light emitted by the display can be altered to improve the functionality of the eye tracking assembly. In addition to calibrating the head mountable device, moving, changing the brightness, or changing the sizes of the visual icons can reduce eye strain by promoting movement or changing the focus of the user's eyes.

In this way, in examples of devices and gaze detection methods described herein, the user does not need to interrupt normal use of the headset to re-calibrate gaze detection. Gaze detection calibration can thus be accomplished quickly, easily, and during use of an existing application such that the user is not even aware calibration or re-calibration has taken place.

In some examples, the head mountable device can include a light seal or fitment feature to selectively or automatically adjust a fit of the head mountable device to the face of a user. The fitment feature can be used to comfortably distribute weight or pressure caused by the head mountable device over the face of the user or to limit or block light from the display or eye tracking assembly.

Gaze detection re-calibration can be performed after adjusting the position of the head mountable device and/or when a preferred or comfortable portion of the display is different for various positions or configurations of the fitment feature. In some examples, the gaze calibration function can execute or operate concurrently with, or responsive to, changes in the configurations of the fitment features. In addition, devices described herein can select comfortable or preferred locations of visual icons at the display after changes to the fitment features. For example, the eye tracking assembly can determine regions where a user's eyes move quicker, are more commonly focused, or have a greater range of motion. These and other examples of devices described herein can therefore reduce gaze fatigue and minimize disruptive calibration steps and instructions.

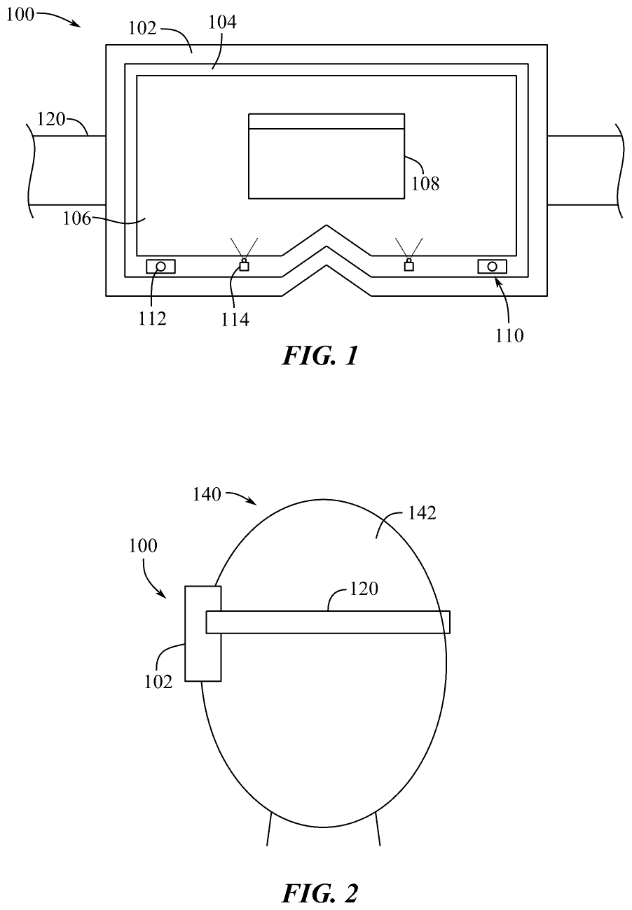

These and other embodiments are discussed below with reference to FIGS. 1-8 However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 and FIG. 2 illustrate an example head mountable display or device 100. The head mountable device 100 can be or include a wearable display device or an electronic display device for depicting visual portions of executable software or multimedia content. The head mountable device 100 includes an optical component or display 106 for depicting visual content. Examples of the head mountable device 100 can include glasses, goggles, or various other types of devices that can be placed in front of eyes of a user 140 to view the content. In some examples, the head mountable device 100 can be an augmented reality (AR) or virtual reality (VR) device.

The head mountable device 100 can include a housing 102. The housing 102 can be a frame or the structure of the head mountable device 100. In one example, the housing 102 defines the body of the head mountable device 100. The housing 102 can include or store electronic or computing components to generate images or visual content on the display 106. For example, the electronic components can include one or more projectors, lighting devices, speakers, processors, batteries, circuitry components including wires and circuit boards, or various other electronic components used in the head mountable device 100 to deliver visuals, sounds, and other outputs, such as for augmented or virtual reality. The housing 102 can include an interior portion 104. The interior portion 104 can be a portion of the housing 102 directed towards or facing the user. In some examples, the interior portion 104 is arranged to be positioned around or between the eyes of a user 140 and the display 106. The interior portion 104 can store, include, or receive one or more the electronic or computing components of the housing 102.

The head mountable device 100 includes the display 106. The display 106 can be or include one or more windows, lenses, screens, or projection surfaces for displaying user selectable software or visual content 108 such as user interfaces. In one example, the display 106 is a single or continuous display. In some examples, the display 106 includes two or more separate lenses, screens, or projection surfaces. The two or more screens can display content at each eye of a user 140 so as to simulate depth or three dimension imagery, or to adjustably focus images unique to each user's 140 eyes. The display 106 can be transparent, semi-transparent, or opaque or transition there between. In transparent or semi-transparent examples, the surroundings of a user 140 can be at least partially visible through the display 106. In such an example, images can be depicted on the display 106 over the surroundings to depict the visual content. In some examples, the head mountable device 100 includes exterior or outward facing cameras or other sensors to capture images or other details of the surroundings and depict the surroundings on the display 106. The surroundings can be hidden or removed or the display 106 can transition to a semi-opaque or opaque state provide a more immersive viewing experience. For example, a background or secondary visual content can be depicted at the display 106.

The display 106 can be used to produce visual portions 108 of executable software, or otherwise generate images on the display 106, such as at screens or lenses. The user selectable software can include, access, or display various applications for entertainment, business and productivity, social networking, communication, gaming, or the like. In some examples, the head mountable device 100 and the display 106 can provide virtual reality or augmented reality experiences by simulating three dimensional imagery or depth in the depicted visual content. The depicted visual content of the executable software or applications can include or represent user selectable functions 108 such as user interfaces or visual icons.

The head mountable device 100 can include one or more eye tracking assemblies 110. The eye tracking assemblies 110 can determine or detect a gaze direction of a user viewing the display 106. The features and components of the eye tracking assembly 110 can be positioned on the interior portion 104 or inward facing side of the housing 102. The eye tracking assembly 110 can include one or more cameras 112 to capture images or visual information of the user's 140 face or eyes. In some examples, the at least one camera 112 positioned at or adjacent each of the user's 140 eyes to capture images or information of each eye, such as a direction of sight or a change in direction.

The eye tracking assembly 110 can include one or more mapping or projecting features 114. The mapping features 114 can be light generating features such as one or more light emitting diodes or other light sources. The mapping features 114 can project light onto or towards a user's 140 eyes or face. The light can be projected at a sufficient brightness, intensity, or wavelength to be unnoticeable or faint in appearance to a user 140. For example, the projected light can be infrared (IR), visible, or various other wavelengths of light. In some examples, the light can be structured or patterned. By projecting structured or patterned light, the user's eyes or a change in position or orientation of the user's 140 eyes can change or deform the pattern of the projection. In one example, the mapping feature 114 includes a light emitting diode configured to reflect light off of an eye of the user 140 to the camera 112. The cameras 112 can capture images or light reflected from the projection to determine the gaze direction of the user. Changes in the shape of portions of the projection, or changes in intensity of the reflected light, can indicate the gaze direction of the user 140. In some examples, one or more images of both eyes, or projections at both eyes, can be compared to determine or refine a determination of the gaze direction of the user 140. In some examples, the gaze direction of each eye can be independently determined, such as examples include two or more viewing areas (e.g. lenses, screens, or projection surfaces).

The head mountable device 100 includes securement features 120 for positioning or supporting the device 100 on a head 142 of the user 140 when the user is donning the device 100. The securement features 120 can be one or more bands, arms, or other features to secure or support the head mountable device 100 to a head 142 of a user 140. The securement features 120 can be coupled to the housing 102. For example, the securement features 120 can extend from or connect to sides of the housing 102. In one example, the securement features 120 can be a band coupled to the housing 102 and configured to secure the head-mountable device 100 to the head 142 of the user 140.

The head mountable device 100 can include or be in communication with one or more components to receive an input or command from a user 140. In some examples, the head mountable device 100 can connect with or be in operative communication with an input device. The input device can be a component configured to receive physical or virtual commands from a user 140 such as a controller, keyboard, mobile phone, or the like. In some examples, the head mountable device 100 can include features or components to track or capture actions or gestures of the user 140 corresponding to an input or function. For example, the head mountable device 100 can include one or more sensors, such as exterior cameras or position sensors, to detect actions of the user 140. The actions or gestures can include movements of the head 142, arms, hands, fingers, legs, feet, or the like of a user 140. The actions can correspond to the intended input or function, such as tapping to interact with an icon of the visual content 108.

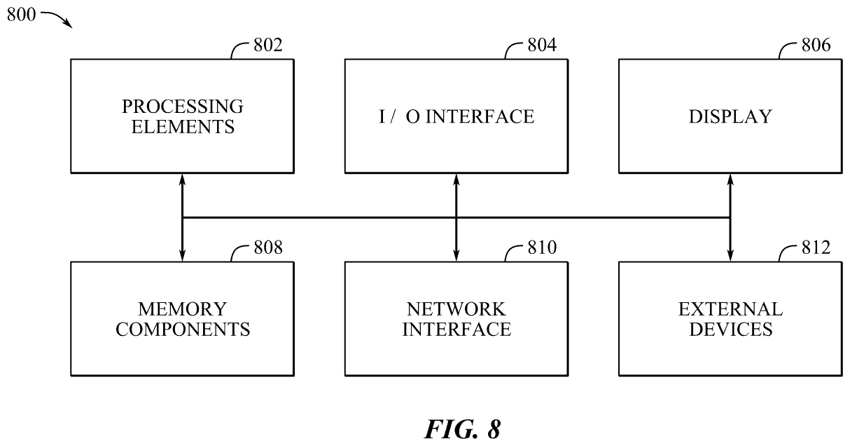

As discussed herein, such as with reference to FIG. 8, the head mountable device 100 can include or be in operative communication with one or more computing systems 800 or devices including a processing element or controller. The processing elements or controllers can execute one or more operations of various software, applications, or the like to perform various functions.

During use, the head mountable device 100 can depict visual content 108 corresponding to various software or applications. The software can include user-selectable software functions, such as controls for multimedia playback or streaming platforms, tools for messaging or interacting with social networking applications, application directories, or the like. The user selectable software functions can be depicted or represented by the visual content 108 such as by one or more visual icons, user interfaces, or the like. The user 140 can interact with the user selectable software functions by providing commands through the input devices or gestures of the user 140, as can be received by or detected by the head mountable device 100. The user 140 can identify the user selectable software function by directing their gaze at a corresponding portion of the visual content 108, such as at an icon. The gaze direction can be detected, captured, or determined by the eye tracking assembly 110. In some examples, the position of the visual content 108 on the display 106 can be known by the head mountable device 100. Accordingly, the position of the visual content 108 at the display 106 can be compared to the gaze direction of the user 140 to determine the relevant user selectable software functions. For example, the user 140 can focus on a portion of the visual content 108 and input a command, and the head mountable device 100 can identify the portion of the visual content 108 by determining the user 140 gaze direction and executing the user selectable software function.

To associate a user's gaze direction with content depicted at the display 106, such as by the eye tracking assembly 110, the components of the head mountable device 100 can require calibration. The calibration can be performed or executed when a user 140 first uses the head mountable device 100 or during use of the device 100. However, after use of the device 100, the calibration of the device 100 can drift or require updating over time to correct or maintain accurate determination of the gaze direction. For example, the positions of the securement features 120 can change, features or accessories of the user 140 can change (e.g. different hairstyles, hats, or facemasks), a different user 140 can use the device 100, or the like. Accurate determination of the gaze direction can be important for visual content 108 of software functions represented by small or closely spaced features or icons, such as keyboards, drop down menus, or the like.

The calibration of the components of the head mountable device 100 can be performed or executed by separate or specialized software function including visual content 108 configured or positioned to assist in determining gaze directions. For example, spaced visual content 108 can be depicted on the display 106 at various known positions, or the visual content positions can move or change. The known positions of the visual content 108 can be compared to a detected or determined positions or orientations of the user's eyes by the eye tracking assembly 110. The differences between the determined or detected positions and the known positions can be identified and corrected to calibrate a user's gaze direction. However, navigating to or executing a dedicated calibration software can be time consuming or disruptive for a user 140 of the head mountable device 100. Accordingly, disclosed herein are systems and methods that can be used to calibrate the head mountable device 100 using the native or existing applications.

In some examples, the calibration of the display 106 or head mountable device 100 can utilize the visual depictions of the user selectable functions of the native or existing applications. Native or existing applications can be applications or software having a primary purpose separate from or in addition to calibration, or otherwise selected by a user for additional purposes such as entertainment, work or productivity, gaming, communication, normal use of the head mountable device 100, or the like. In some examples, a calibration function can be executed in combination with the user selectable software functions for a user 140 to continue normal use of the head mountable device 100 and to calibrate to the user's gaze direction. For example, a user 140 can direct their gaze at one or more various visual depictions of user selectable software functions. The visual depictions can be icons or user interfaces 108 where the user's gaze is predicted, known, tracked, or the like. When the user 140 looks at the visual depiction 108, the head mountable device 100 can execute a separate or additional function for gaze direction calibration, such as by comparing the user's gaze direction to the known location of the visual depiction 108 at the display 106. For example, a controller or processing element electrically coupled to the display 106 and the eye tracking assembly 110 can execute a gaze direction calibration including detecting, via the camera 112, the gaze direction when the user 140 looks at a visual depiction of the user selectable software function. The gaze calibration operation can be activated at the request of the user 140, executed automatically by the head mountable device 100, such as when one or more conditions are satisfied for calibration, or when the head mountable device 100 determines the gaze calibration is in need of correction or modification.

Any of the features, components, and/or parts, including the arrangements and configurations thereof shown in FIG. 1 or FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1 or FIG. 2.

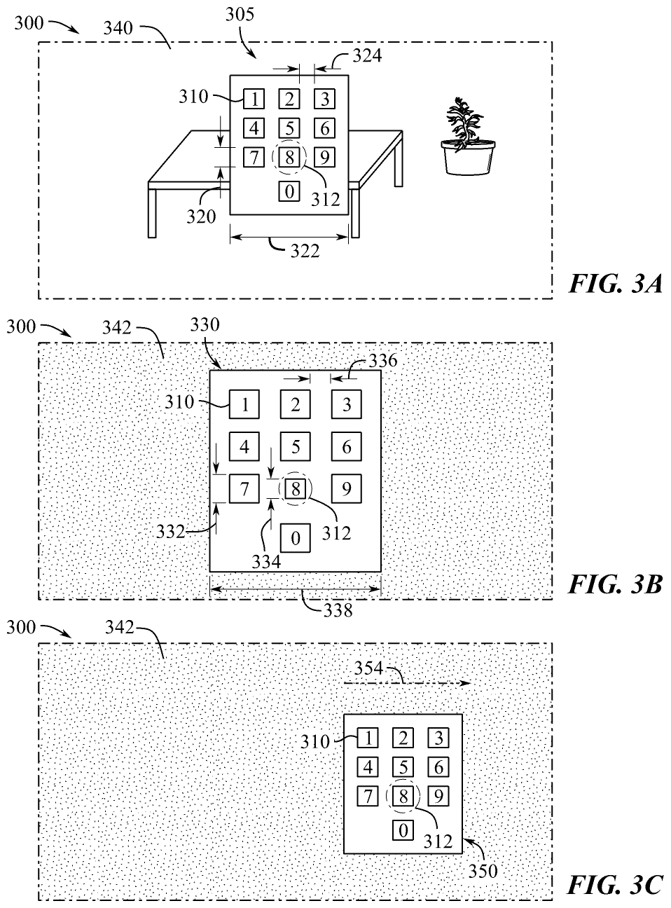

FIGS. 3A-3C illustrate example native or existing software or application for calibration of the head mountable device 100. In some examples, the native or existing software applications can include visual depictions of user selectable executable software that are known, predicted, or likely to be selected by a user 140. For example, the user selectable features or operations can be icons, images, text or other features commonly used or selected during start up or initial use of the device 100. In such an example, the user's 140 gaze direction can be predicted or verified by comparing the gaze direction to the known position of the feature on the display 106.

FIG. 3A depicts an example display 300 from the perspective or field of view of a user 140 by the head mountable device 100. The display 300 can be representative of the entirety or a portion of the display 106. The display 300 can depict or include a user interface 305 including one or more known or predicted user selectable features such as an icon 310. The user interface 305 can be presented at startup of or logging into the head mountable device 100, during use of the head mountable device 100, or when shutting down or signing out of the device 100. For example, the user interface 305 can correspond to a lock or unlock function or login screen. The icons 310 can include or represent number pads, keyboards, or other inputs. At least one of the icons 310 can be a focused icon 312 that is known, predicted, likely to be, or currently within the gaze direction of the user 140. For example, the focused icon 312 can be an icon 310 known to be part of a passcode or log in to the head mountable device 100.

The user interface 305 can be depicted having a known interface size dimension or portion 322 (e.g. width, height, depth) of the display 300. The various icons 310 can have a known size or icon dimension 320. The various icons 310 can be positioned at known locations or separated by known spacing dimensions 324. For example, each icon can be spaced laterally, vertically, or the like by the spacing dimension 324.

The user interface 305 can be positioned on the display 300 overlaying or in combination with a background 340. The background 340 can be a screensaver, collage, images, colors, patterns, or the like. The background 340 can change or transition between various visual depictions during use, such as between two or more images. The background 340 can selected by the user or predetermined by the head mountable device 100. In some examples, the background 340 can be a secondary user interface or other application. The background 340 can change or transition between various visual depictions during use, such as between two or more images. In one example, the background 340 can be the surroundings of the user 140, such as by a transparent display or pass through, or by capturing and displaying images of the surroundings.

At operation, the user selectable software function or user interface 305 can be used in combination with a gaze calibration function. For example, during use of the user interface 305 the user can look at a visual icon 310 representing a user-selectable software function and the user-selectable software function can include a separate function, such as an unlock function, independent of the gaze direction calibration. With reference to the user interface 305 representing an unlocking interface, the positions of the icons 310 at the display 300 can be known to the device 100. Further, the order and positions a user 140 will direct their gaze to the icons 310 can be known, predicted, or likely, such as to the focused icons 312. For example, with reference to FIG. 3A, the focused icon 312, number “8,” can be a known component of the passcode. The device 100 can predict the gaze of the user 140 will be directed to the focused icon 312. Accordingly, when the user's gaze is directed to the focused icon, the gaze direction can be captured by the eye tracking assembly 110, such as by the one or more cameras 112. The captured gaze direction can be compared to the known position of the icon 312 at the display 300. Differences between the captured or detected gaze direction and the known position of the icon 312 can be identified and corrected to calibrate the device 100. The calibration can include determining the gaze direction relative to or towards additional icons 310, 312, such as at various positions of the display 300, to further calibrate the device 100. In some examples, the movement of the user's eyes or gaze, such as during transitions between icons 310, 312, can be tracked for calibrating the device 100. For example, how a user's eyes move or stop can be useful in determining whether a user is scanning, searching, or focusing on various portions of the display 300, or for comparing the known dimensions of the user interface 305 or display to detected ranges of motion of the user's gaze.

In some examples, one or more characteristics of the user selectable software function can be altered during or for gaze calibration. FIGS. 3B and 3C depicts example alterations of various characteristics of a user selectable software for gaze calibration. By varying one or more characteristics of the display 300 or visual depictions of the user selectable software, additional positions of the user's eyes or gaze directions can be captured to assist in calibrating the device 100. As shown in FIG. 3B, the display 300 can transition to or depict a second visual depiction or configuration of a user interface 330 representing the software. The second user interface 330 can similarly include one or more icons 310, such as a focused icon 312. The second user interface 330 can include altered characteristics such as a different arrangement of the icons 310 or be positioned having one or more different dimensions.

The altered characteristic of the user selectable software function can be an increased size of the icon or visual depictions 310, 312. In some examples, the icons 310 of the second user interface 330 can be positioned to have a larger dimension 332 (e.g. height, width, area). For example, an icon 310 can have the larger dimension 332 compared to additionally displayed icons 310, or as compared to an initial dimension 320 of the icon. The larger dimension 332 can provide a larger target or region of the display 300 for a user 140 to direct their gaze. The larger target can assist in determining initial gaze positions or how a user's eyes can move or adjust while viewing an icon 310.

The altered characteristic of the user selectable software function can be a decreased size of the icon 310, 312 or visual depictions. In some examples, the icons 310, 312 can have a smaller dimension 334, such as with reference to the focused icon 312 in FIG. 3B. The icon 312 can have the smaller dimension 334 compared to additionally depicted icons 310 at the display 306, or as compared to an initial dimension 320 of the icons 310. The smaller dimension 334 can provide a smaller target for a user's gaze. The smaller visual icon 312 can assist in directing or tightening the focus of a user's eyes to assist in calibrating for scenarios where a user selectable function is relatively small or surrounded by adjacent user selectable functions. In some examples, the smaller target can assist in correlating or comparing the gaze of each eye as a component of the gaze direction by requiring each eye to more precisely align to view the icon 312. In some examples, a comparatively differently sized icon 310, 312 can require a user's gaze to move differently compared to movement between identically sized icons 310. As a result, the differently sized icons 310 can also assist the eye tracking assembly 110 in gathering information regarding the movement of a user's 140 gaze.

The altered characteristic of the user selectable software function can be changes in distances or spacing between the icons 310, 312 or visual depictions. In some examples, the spacing dimension 324, or distances between icons 310, can be increased or decreased during or for gaze calibration. In some examples, the distances between icons 310 can be increased to a larger distance 336. By increasing the distances 336 between icons 310, a user's eyes can move a greater amount or degree to transition between icons 310. The larger distances 336 can assist in capturing information or identifying the movement of a user's gaze between the icons 310. The greater distance 336 between icons 310 can separate the direction of a user's gaze between icons 310 to assist in identify and comparing the gaze direction and the known position of the icons 310.

The altered characteristic of the user selectable software function can be a change in the total size of a user interface 305, 330 or window of the visual representations of the software or applications. In some examples, the overall size or dimensions 338 of the user interface 330 can be increased or decreased compared to the initial interface 305. The increase in dimensions 338 of the user interface 330 can require additional eye movement from a user 140 to direct their gaze at the icons 310. The additional eye movement can assist in capturing information and comparing the movement of a user's eyes in multiple different directions (e.g. up, right, left, down, or combinations thereof). Further, causing a user 140 to move their eyes or change their focus on varying targets, such as the icons 310, can assist in reducing eye strain. For example, a user interface 330 dimension that is reduced can cause a user's eyes to change focus similarly to viewing an object at a greater distance. Reduction in eye strain can be good for a user's eye health, generally, and also assist in allowing a user 140 to utilize the head mountable device 100 for greater durations.

The altered characteristic of the user selectable software function can be a location of the visual icon 310, 312 or user interface 350 on the display 300. In some examples, the user interface 350 can be moved from an initial position by a direction 354. The user interface 350 can be moved during calibration or operation of the user-selectable software function (e.g. during unlocking). In other examples, the user interface 350 can be moved by positioning the user interface 350 at varying positions during separation uses of the software function, such as between unlocking operations. The varying positions of the user interface 350 can assist in capturing and calibrating for a user's gaze direction in a variety of orientations. For example, by positioning the user interface 350 in a bottom corner, the user 140 can gaze generally downward and to the side while also changing their gaze between icons 310 in that direction. In other examples, the user interface 350 can be positioned or moved in a variety of directions to determine or calibrate a user's gaze for a variety of portions of the display 300.

The altered characteristic of the user selectable software function can be an amount of light emitted by the display 300, icons 310 on the display 300, or other visual depictions. In some examples, the background of the display 300 can be transitioned from a first background 340 to a second background 342. The second background 342 can emit more or less light by the display 306 in comparison to the first background 340. For example, a pass through or image background 340 can transition to a darker image or solid or shaded background 342. In some examples, the overall brightness of the display 300 can be reduced. The reduction in the amount of light emitted by the display 300 can assist in the calibration function by limiting interference with the light emitted by the mapping feature or light 114, or the capture of the projections by the cameras 112. For example, various colors or levels of brightness can interfere with or cover the projections of the mapping feature 114 or create glare or reflections from the user's eyes or skin. By reducing the amount of light emitted by the display 300, such as by changing the background 340, 342, the eye tracking assembly 110 can more effectively capture or determine gaze directions. The change in the amount of light emitted by the display 300 or the background 342 can be in response to the activation of the calibration function, or the calibration function can activate when the amount of light falls below at least a threshold level of brightness. In some examples, the user 140 can change the background to begin calibration, or calibrating can automatically begin upon changing a background.

The examples and devices shown in FIGS. 3A-3C and described herein can thus enable a user and/or a device to calibrate and re-calibrate gaze detection functionalities of the device 100 without the need to interrupt the user's interaction with the user-interface 305, including interactions with software applications displayed by the device 100 in the normal course of use. In some examples, the gaze detection calibration can occur without the user even knowing, as the user interacts with native applications and interfaces, rather than extra and burdensome calibration steps interrupting normal use and interactions with the device 100.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

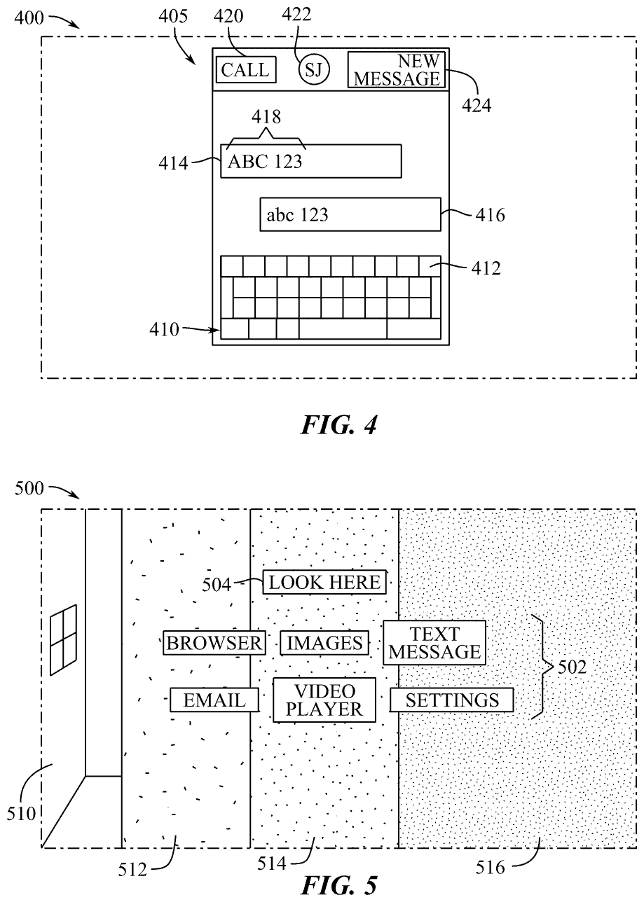

FIG. 4 illustrates another example of native or existing software or application for calibration of the head mountable device 100. In some examples, the existing or native application used for calibration functions can include a user interface or visual depictions 405 at a display 400 including commonly selected icons or user selectable features. In one example, the native or existing application can be a messaging or social media application. The user selectable functions of the native application can be represented by a user interface 405 depict-able at the display 400.

The messaging user interface 405 can include a variety of various icons that can be commonly or predicted to be selected by the user 140 of the head mountable device 100. The messaging user interface 405 can include user selectable functions including typing. For example, the messaging user interface 405 can include or depict a keyboard 410 having a plurality of selectable characters 412. The messaging user interface 405 can depict incoming 414 and outgoing messages 416, including text or other characters 418. The user interface 405 can depict icons having commonly used features such as an icon 420 to initiate a video or audio call, a contact identifier 422 of another user in correspondence, or a new message or chat feature 424.

The various icons and features of the user interface 405 can be depicted at known positions of the display 400. When a user 140 directs their gaze at the various known icons and features, the calibration function can be executed to calibrate the head mountable device 100. In some examples, the calibration function can run concurrently with the native app. For example, the call 420, contact 422, or new message icons 424 can be commonly selected by a user 140 and when a user's gaze is directed towards the icons the calibration of the device 100 can be activated or updated based on the detected direction of the users gaze, such as by the eye tracking assembly 110.

In some examples, icons or features such as the messages 414, 416 or the keyboard 410 can provide varying but predictable or anticipated gaze directions for calibrating the device 100. For example, when reviewing messages 414, 416 it can be anticipated or predicted that the user can direct their gaze to the messages 414, 416 in a chronological order (e.g. top to bottom, or left to right). In some examples, it can be anticipated that the gaze direction at or towards the messages 414, 416 will be associated with reading and user's gaze will shift along the text 418 in a known order, such as left to right. With reference to the keyboard 410, while an initial character or string of words corresponding to an ordered selection of characters or symbols 412 can be more difficult to predict, the more characters input to define a word or a the more words organized to define a sentence, the more likely a specific character or series of characters 412 can be anticipated or predicted. In such examples, the gaze calibration function can be activated or updated as the eye tracking assembly 110 captures a user's gaze directed to the various predicted or anticipated character icons 412. For example, the gaze calibration function, such as by the eye tracking assembly 110, can detect any differences between the determined or calibrated user's gaze direction and the known position of the predicted icons at the display 400 and correct for the errors.

In this way, any number of visual characters or symbols 412 presented by various software applications can be used for gaze detection calibration without the need for calibration dedicated protocols and interruptions. Other software applications and symbols/displayed icons not shown in FIG. 4 can also be employed similarly for gaze detection calibration. In one or more other applications, the device 100 can learn over time which applications are more commonly used by different users and tailor the icons used for gaze detection calibration to individual user use patterns.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 illustrates another example of a display 500 including one or more icons 502 representative of a user selectable function for calibration of the head mountable device 100, which can be used to seamlessly and quickly calibrate gaze detection of a user. For example, the icons 502 can be representative of various applications or software arranged in a home screen, navigation page, or the like, without the need for separate dedicated calibration icons, steps, and so forth.

The icons 502 can include at least one icon 504 that is commonly viewed by the user 140 or designed to draw the attention of the user. A commonly viewed or used icon 504 can be an icon used to navigate between icons 502, position or arrange the display 500 (e.g. volume, magnification, or scroll feature), or the like. In some examples, the icon 504 can be designed to draw the attention of a user 140 to initiate a calibration function without navigating to a separate display or application. For example, if the device 100 or eye tracking assembly 110 determines the gaze direction calibration has drifted or has become inaccurate, the icon 504 can be added to the display 500 or made more prominent at the display 500 to draw the gaze of the user 140. The gaze calibration function can be activated before or during display of the icon 504, or when the user's gaze is directed towards the icon 504. After activating the gaze calibration function, the calibration of the device 100 can be updated by capturing or comparing the position of the icon 504 to the gaze direction of the user 140.

In some examples, the background 510 of the display 500 can be cycled before, during, or after the user 140 directs their gaze to the attention icon 504. For example, if the device 100 or eye tracking assembly 110 determines the gaze direction calibration has drifted or has become inaccurate, the display 500 can cycle or change between one or more darker or dimmer backgrounds 512, 514, 516. By cycling through the backgrounds 512, 514, 516 the execution of the gaze calibration function can be assisted or completed quicker to reduce or limit time spend by the user 140 calibrating the device 100 by preventing inference with the eye tracking assembly 110.

In some examples, cycling backgrounds 512, 514, 516 can confirm or validate the status of the gaze calibration (e.g. accurate or inaccurate). For example, in some examples the gaze calibration can be accurate but the light output of the display 500 can be too bright for the operation of the eye tracking assembly 110, such as by hiding or covering the projections from the lights 114. By cycling the backgrounds 510, 512, 514, 516 the eye tracking assembly 110 can determine if the gaze calibration requires updating.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

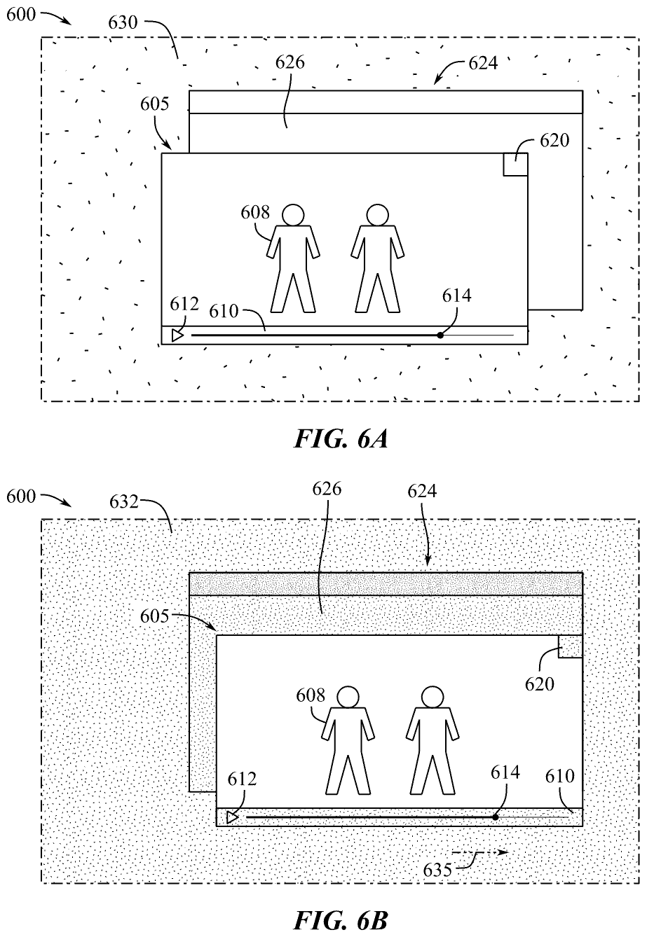

FIG. 6A and FIG. 6B illustrate example native or existing software or application including two or more user interfaces at a display 600, such as a first user interface 605 and a second user interface 624 for calibration of the head mountable device 100.

The first user interface or user selectable software function 605 can correspond to a streaming or multimedia executable software and depict a video streaming window 605. The video streaming window 605 can include or depict video content 608. The video streaming window 605 can include one or more icons for interactivity or control of the video content 608. For example, the video streaming window 605 can include or depict a control panel 610 including a playback control icon 612 and a moving or movable time or status indicator 614. In some examples, the video streaming window 605 can include additional control or information icons 620.

The second user interface or visual depiction 624 can be representative of a variety of software or executable applications. To prioritize viewing of the content 608, the video streaming window 605 can overlap or be depicted over the second user interface 624 at the display 600. In such examples, user selectable functions of the second user interface 624 can be ignored or hidden, or at least with respect to gaze related calibration or inputs. The first user interface 605 and the second user interface 624 can be depicted over a background 630.

During operation, at least the video streaming window 605 can be moved to assist in execution of the calibration function or to reduce eye strain of the user 140 otherwise due to prolonged viewing of content 608 at a fixed position. To reduce the eye strain, the processing elements or controllers of the device 100 can cause the video streaming window 605 to move relative to a peripheral edge of the display 600, such as in direction 635.

The movement of the video streaming window 605, or various other icons or user interfaces, can assist in executing the calibration function by comparing known changes in positions over time, or movement, of the streaming window 605 to changes in gaze direction and correcting differences to calibrate the device 100. While the content 608 can change positions or visually during the calibration operation, one or more icons, such as the playback icon 612, can be fixed in position relative to the video streaming window 605. Accordingly, the gaze direction calibration can include detecting, such as by the camera 112, the gaze direction when the user 140 looks at the icon 612 when the video streaming window 605 location is changing. As the video streaming window 605 moves relative to the display 600, the playback or fixed icon 612 can be used as a fixed point to compare differences in detected or determined gaze location and the position of the icon 612 on the display 600 to update the calibration. In some examples, the movement of the time or status indicator 614 can be used to determine or update calibration by changes in positions of the icons over time.

In some examples, the movement of the video streaming window or user interface 605 can be based on a change in position of the housing 102. For example, the external cameras or position sensors can detect or determine a position or change in position of the housing 102. The controller or processing elements can be electrically or operatively connected with the position sensors. When the position sensor determines a change in position of the housing, the controller can activate the movement or gaze calibration function to change the location of the video streaming window or user interface 605. The changed location or movement can be to a position within a more comfortable or less straining portion of the display 106 for viewing by the user 140.

In some examples, the brightness or output of light by the display 600 can disrupt or interfere with the gaze direction calibration, as discussed herein. To reduce the output or intensity of light, a second or darker background 632 can be depicted at the display 600. In some examples, one or more portions of the first user interface or video streaming window 605 or the second user interface 624 can change to visually depict a darker or night mode theme. For example, the second user interface 624 can have a body 626 that can change to a darker theme or an inverted color (e.g. white on black text) to reduce a light output. In some examples, such as with a video streaming window 605, the changing the color theme of the content 608 can be impractical. However, control features or icons of the video streaming window 605, such as the control panel 610 or information icon 620, can be updated or replaced to depict darker or dimmer shades or colors. The reduced output of light can also reduce eye strain of a user 140 viewing the display 600.

Any of the features, components, and/or parts, including the arrangements and configurations thereof shown in FIG. 6A, FIG. 6B, or FIG. 6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6A, FIG. 6B, or FIG. 6C.

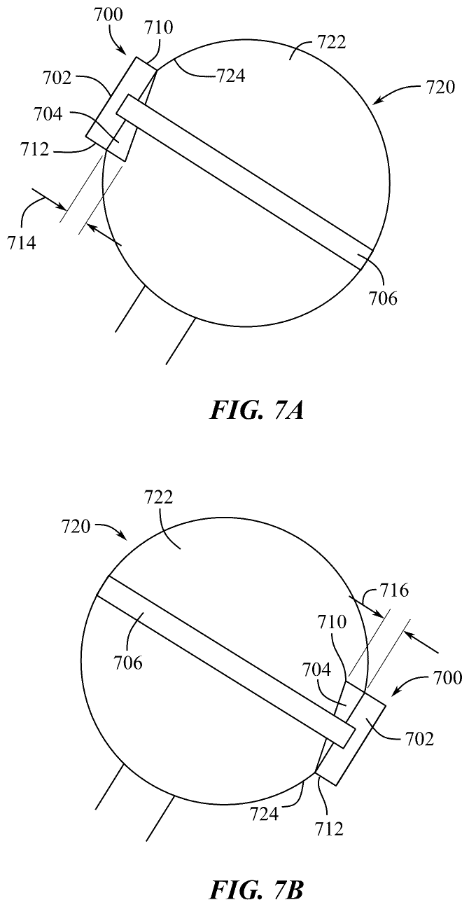

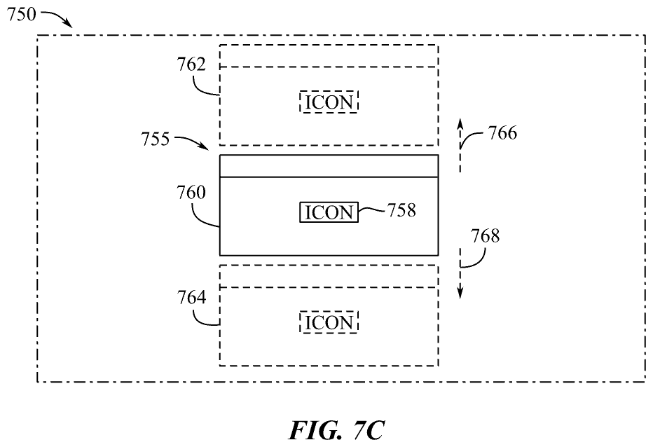

FIG. 7A-7C illustrate an example of the head mountable device 700 including fitment features 704. The head mountable device 700 can include features similar to the head mountable device 100. For example, the head mountable device 700 includes a housing 702 coupled or connected with a display 750. The head mountable device 700 includes one or more securement features 706 connected to the housing 702 for securing the head mountable device 700 to a head 722 of a user 720. The head mountable device 700 can include the eye tracking assembly 110, including one or more cameras 112 and mapping features or light sources 114.

The fitment features 704 of the head mountable device 700 can be positioned towards the interior or inward facing portions of the head mountable device 700. The fitment features 704 can include seals, pads, or structures to block light from the display 750 or to disperse forces comfortably or securely about a face 724 of the user 720.

The fitment features 704 can selectively or automatically adjust to an orientation or body position of the user 720 to block light or disperse pressure comfortably about the face 724 of the user 720. For example, when a user 720 is facing upward, such as in FIG. 7A, the fitment feature 704 can be expanded along a bottom side 712 to a greater width 714 than a top side 710 of the housing 702 or device 700. The expansion of the fitment feature 704 along a portion of the bottom 712 can reduce pressure on the checks or lower face 724 of the user 720 and increase the weight across a forehead to more evenly distribute the weight of the device 700. When a user 720 is facing downward, such as in FIG. 7B, the fitment feature 704 can be expanded to have a greater top width 716 at the top 710 of the housing 702 to reduce pressure on the forehead and increase weight on the lower face to more evenly distribute the weight of the device 700. In some examples, either the top side 710 or the bottom side 712 of the fitment feature 704 can be expanded or retracted based on the facial structures, positions, or preferences of the user 720.

With reference to FIG. 7C, the changes in position of the fitment features 704 can change the position of the display 750 or the eye tracking assemblies 110 relative to the eyes of the user 720. For example, the increased bottom width 714 can cause a visual portion of a user selectable function, such as a user interface 755, to appear to move upward 766 on the display 750 to an upper position 762 from an initial or central position 760 relative to the eyes of the user 720. In some examples, the increased top width 716 can cause the user interface 755 to appear to move downward 768 on the display 750 to a lower position 764. Accordingly, a change in position of the fitment features 704 can cause a processing element or controller to activate a calibration function, such as by comparing a user's gaze direction at the icon 758 to a known position of the icon 758 at the display 750 and correct for the differences to seamlessly and quickly calibrate gaze detection of a user.

In some examples, changes in positions of the fitment features 704 can change a preferred position of the visual icons or user interface 755 within the display 750. For example, an increase in width of the fitment features 704 along one portion of the device 700 can decrease the eye strain or effort to view a corresponding portion of the display 740. In some examples, the eye tracking assemblies 110 can determine a preferred orientation of the interface 755, such as adjusting to the upper 762 or lower positions 764, based on the range of motion or frequency of a user's gaze directed at the corresponding portion of the display 750. In some examples, a user 720 can set a preferred orientation of the user interface 755 about the display relative to a position of their eyes. In such an example, the gaze calibration function can determine a difference between the position of the user's eyes and the display 750 or user interface 755 and correct the position of the user interface 755 at the display 750. Accordingly, the user selectable software function 755 or icons 758 depicted at the head mounted device 700 can be adjusted or positioned automatically or fluidly depending on the orientation of the user 720 or the fitment features 704.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

FIG. 8 is a schematic diagram of an example computer system 800 for implementing various embodiments in the examples described herein. The computer system 800 can be used to implement various computing steps or methods, such as the calibration functions or user selectable software features. The computer system 800 can be integrated into one or more head mountable devices 100, 700 or eye tracking assemblies 110.

As shown in FIG. 8, the computer system 800 can include one or more processing elements 802, an input/output interface 804, a display 806, one or more memory components 808, a network interface 810, and one or more external devices 812. Each of the various components can be in communication with one another through one or more buses, communication networks, such as wired or wireless networks.

The processing element 802 can be any type of electronic device capable of processing, receiving, and/or transmitting instructions. For example, the processing element 802 can be a central processing unit, microprocessor, processor, or microcontroller. Additionally, it should be noted that some components of the computer 800 can be controlled by a first processor and other components can be controlled by a second processor, where the first and second processors can or may not be in communication with each other.

The memory components 808 are used by the computer 800 to store instructions for the processing element 802, as well as store data. The memory components 808 can be, for example, magneto-optical storage, read-only memory, random access memory, erasable programmable memory, flash memory, or a combination of one or more types of memory components.

The display 806 provides visual feedback to a user. Optionally, the display 806 can act as an input element to enable a user to control, manipulate, and calibrate various components of the system. In some examples, display 806 or be separate from the display of the head mountable device 100, 700. The display 806 can be a liquid crystal display, plasma display, organic light-emitting diode display, and/or other suitable display. In embodiments where the display 806 is used as an input, the display can include one or more touch or input sensors, such as capacitive touch sensors, a resistive grid, or the like.

The I/O interface 804 allows a user to enter data into the computer 800, as well as provides an input or output for the computer 800 to communicate with other devices or services. The I/O interface 804 can include one or more input buttons, touch pads, and so on. The I/O interface 804 can be a digital or analog I/O interface 804. A digital I/O interface 804 can generate or receive digital or discrete (e.g. binary) signals. An analog I/O interface 804 can generate or receive analog or time varying signals.

The network interface 810 provides communication to and from the computer 800 to other devices. The network interface 810 includes one or more communication protocols, such as, but not limited to Wi-Fi, Ethernet, Bluetooth, and various other protocols such as Ethernet for Control Automation Technology (EtherCAT), Internet protocol (IP), Modbus, Profinet, ControlNet, DeviceNet, or Common Industrial Protocol (CIP). Any or all of which can be communicated or connected through wireless transmissions or radios or through physical media such as electrical or optical cables. The network interface 810 can also include one or more hardwired components, such as a Universal Serial Bus (USB) cable, or the like. The configuration of the network interface 810 depends on the types of communication desired and can be modified to communicate via Wi-Fi, Bluetooth, and so on.

The external devices 812 are one or more devices that can be used to provide various inputs to the computing device 800 such as the various features of the system as described herein or additional devices, e.g., controllers, mouse, microphone, keyboard, trackpad, or the like. The external devices 812 can be local or remote and can vary as desired.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data can be used to provide insights into a user's general wellness, or can be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

1. A head-mountable display, comprising:
a display;
an eye tracking assembly including a camera configured to detect a gaze direction of a user donning the display; and
a controller electrically coupled to the display and the eye tracking assembly, the controller configured to execute a gaze direction calibration including detecting, via the camera, the gaze direction when the controller predicts the user looks at a visual icon representing a user-selectable software function;
wherein the user-selectable software function includes a function independent of the gaze direction calibration.

2. The head-mountable display of claim 1, further comprising:
a housing coupled to the display; and
a securement band coupled to the housing and configured to secure the head-mountable display to a head of the user;
wherein the eye tracking assembly further includes a light emitting diode configured to reflect light off of an eye of the user to the camera.

3. The head-mountable display of claim 1, wherein:
the separate function includes typing; and
the visual icon includes a keyboard.

4. The head-mountable display of claim 1, wherein the separate function includes a user-interface unlock function.

5. The head-mountable display of claim 4, wherein the visual icon includes a number pad.

6. The head-mountable display of claim 1, wherein the visual icon includes a video streaming window.

7. The head-mountable display of claim 6, wherein the controller is configured to cause the video streaming window to move relative to an edge of the display.

8. The head-mountable display of claim 1, wherein at least one dimension of the visual icon representing the user-selectable software function is increased or decreased during the gaze direction calibration.

9. An electronic display device, comprising:
an eye tracking assembly including a camera;
a display; and
a controller electrically coupled to the display and the eye tracking assembly, the controller configured to:
cause the display to project a visual icon representing a user-selectable software function, the visual icon having a characteristic; and
execute a gaze direction calibration when the controller predicts a user is looking at the visual icon, the gaze direction calibration including:
altering the characteristic when a user looks at the visual icon; and
detecting, via the camera, the gaze direction when the user looks at the visual icon.

10. The electronic display device of claim 9, wherein the user-selectable software function includes a separate function independent of the gaze direction calibration.

11. The electronic display device of claim 9, wherein the characteristic includes an amount of light emitted by the visual icon on the display.

12. The electronic display device of claim 9, wherein the characteristic includes a size of the visual icon.

13. The electronic display device of claim 9, wherein the characteristic includes a location of the visual icon on the display.

14. The electronic display device of claim 13, wherein the visual icon comprises a video streaming window.

15. The electronic display device of claim 14, wherein the controller is configured to alter the location of the video streaming window by moving the video streaming window relative to an edge of the display.

16. A wearable display device, comprising:
a display defining a viewing area having a peripheral edge;
a controller electrically coupled to the display and configured to:
cause the display to project a video streaming window within the viewing area; and
change a location of the video streaming window relative to the peripheral edge over time.

17. The wearable display device of claim 16, further comprising:
a housing coupled to the display; and
a position sensor electrically coupled to the controller and configured to detect a position of the housing;
wherein the controller is configured to change the location based on the position.

18. The wearable display device of claim 16, wherein:
the controller is configured to cause the display to project a visual icon in a fixed position relative to the video streaming window;
the wearable display device further comprises a camera; and
the controller is electrically coupled to the camera and configured to execute a gaze direction calibration including detecting, via the camera, the gaze direction when a user looks at the visual icon when the video streaming window location is changing.

19. The wearable display device of claim 18, wherein the visual icon represents a user-selectable software function independent from the gaze direction calibration.

20. The wearable display device of claim 19, wherein the camera is adjacent the display.
